(19) United States
(12) Patent Application Publication
(10) Pub. No.: US 2016/0071139 A1
(43) Pub. Date: Mar. 10, 2016

(54) PREAUTHORIZE BUYERS TO COMMIT TO A GROUP PURCHASE

(71) Applicant: PAYPAL, INC., San Jose, CA (US)

(72) Inventor: Darrell Esch, San Jose, CA (US)

(21) Appl. No.: 14/942,944

(22) Filed: Nov. 16, 2015

Related U.S. Application Data
(63) Continuation of application No. 13/852,980, filed on Mar. 28, 2013.
(60) Provisional application No. 61/638,289, filed on Apr. 25, 2012.

(51) Int. Cl. G06Q 30/02; G06Q 20/40; G06Q 30/06; G06Q 20/12

(52) U.S. Cl. CPC G06Q 30/0222; G06Q 20/12; G06Q 20/40; G06Q 30/0605

(57) ABSTRACT

A payment provider preauthorizes and commits consumers to a group purchase when the consumers provide an indication or intent to make a group purchase. Upon receiving the intent, the payment provider may ask the consumer whether they wish to irrevocably commit to the purchase at the advertised price. If so, the payment provider may hold or freeze the appropriate amount in the user account or otherwise commit the funds to the merchant if the minimum number of purchasers is met for the group purchase. The payment provider may release the funds to a merchant account even if the consumer decides, after the initial commitment, to not make the group purchase. Thus, others who committed to the group purchase will still be able to take advantage of the group deal.

### RELATED APPLICATIONS

The present application is a continuation of U.S. Patent Appl. Ser. No. 13/852,980, filed Mar. 28, 2013, which claims priority to Provisional Patent Appl. Ser. No. 61/638,289, filed Apr. 25, 2012, all of which are herein incorporated by reference in their entirety.

### BACKGROUND

1. Field of the Invention

The present invention generally relates to financial transactions, and in particular, to group purchases.

2. Related Art

With the increased use of social networks and sites, consumers are making more and more group purchases, in which a group of consumers purchase one or more items at a lower price than they would be able to purchase individually. For example, a merchant may offer a lower price on an item, but only if a minimum number of consumers agrees to make the purchase. Thus, if some consumers decide to not make the group purchase, the lower price may not be available to the remaining members of the group because the minimum number set by the merchant may have not been met any more.

Therefore, a need exists to ensure a group receives the lower group price when a sufficient number of consumers commit to the group purchase.

### BRIEF DESCRIPTION OF THE FIGURES

FIG. 1 is a flowchart showing a process for committing a consumer to a group deal according to one embodiment;

FIG. 2 is a block diagram of a networked system suitable for implementing the process of FIG. 1 according to an embodiment; and

FIG. 3 is a block diagram of a computer system suitable for implementing one or more components in FIG. 2 according to one embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

According to one embodiment, a payment provider preauthorizes and commits consumers to a group purchase when the consumers provide an indication or intent to make a group purchase. For example, a merchant may offer a lower price of an item, but only if 100 consumers make the purchase or a group is formed to contribute to a purchase shared by the group, such as a vacation rental or television to be shared by the group. Consumers or members of the group may decide they would like to take advantage of the offer, so they commit to making the purchase. For example, they may select a link or button to convey their intent to the merchant.

A payment or service provider may then preauthorize and commit the consumer to the purchase. Upon receiving the intent, the payment provider may ask the consumer whether they wish to irrevocably commit to the purchase at the advertised price. If so, the payment provider may process a payment request from the consumer to the merchant, but without actually moving funds to a merchant account. If the payment request can be approved, the payment provider may hold or freeze the appropriate amount in the user account or otherwise commit the funds to the merchant if the minimum number of purchasers is met for the group purchase.

If the minimum number of purchasers is not met and/or the merchant cannot fulfill the group offer, the payment provider may take off the hold or release the funds back to the consumer's account. However, if the minimum number is met, the payment provider may release the funds to a merchant account even if the consumer decides, after the initial commitment, to not make the group purchase. Thus, others who committed to the group purchase will still be able to take advantage of the group deal.

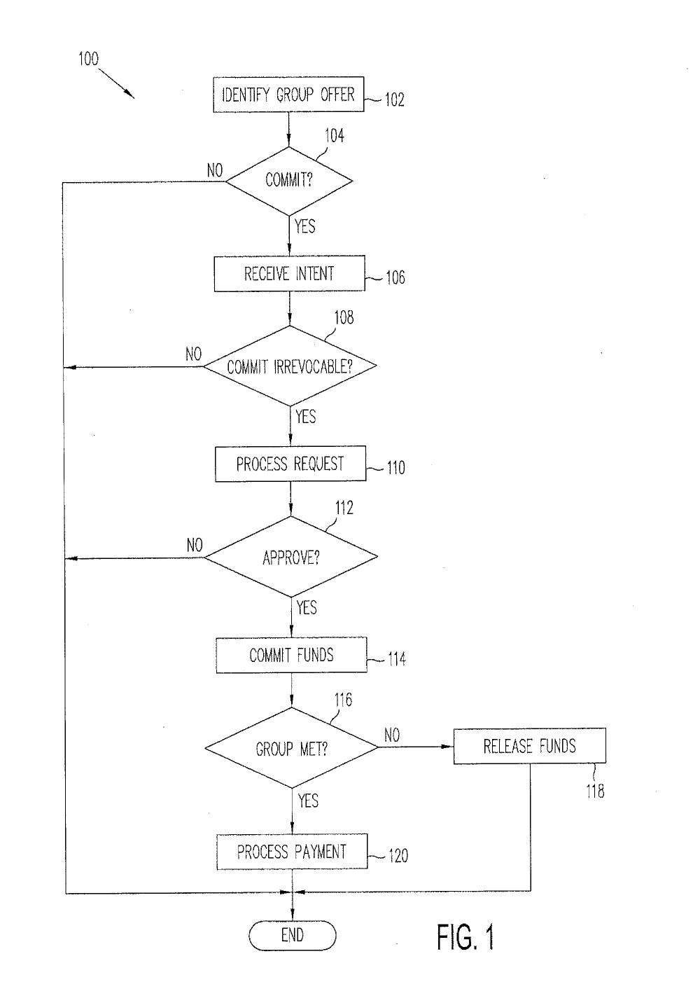

FIG. 1 is a flowchart showing a process 100 for committing a consumer to a group deal according to one embodiment. At step 102, a consumer or user identifies a group offer of interest. A group offer may be any type of offer made by a merchant or seller of an item or items, where the offer is valid only if a certain number of consumers commit to or purchase the item(s) or an offer of an item where a group of consumers will be contributing to make the purchase of the item. Items may be physical goods, digital goods, services, donations, and the like. The offer may be from an email, a website, a text message, a print publication, etc. The offer may include specific details of the offer, such as a description of the item, price, number of purchasers needed, and an expiration date if applicable. The offer may also include instructions on how to commit or opt in to the offer, such as a button or link, an email address, a URL address, etc.

The group offer may be for a plurality of a single item, where each consumer purchasing within the group receives the item. The group offer may also be a single item shared by a group of consumers, such as a vacation rental, a television for a group clubhouse, etc.

Next, at step 104, the consumer determines whether they want to commit to the offer. If the consumer wishes to commit, an intent to commit to the offer is received at step 106. This can be in different forms and different ways, depending on the group offer. For example, if the offer is for a condo rental, a group of people may decide to purchase a condo rental in Lake Tahoe for the Christmas holidays. The intent to commit may be received by one or more other members of the group, such as the consumer telling one or more of the others that he is in for the trip. If the offer is for an individual purchase of each consumer in the group of an item, where each consumer pays full price for the item at the offered price and receives the item, the intent to commit may be received by the consumer selecting an appropriate button or link or sending a message (text, call, or email) to the merchant making the offer. In another example, the intent may be more explicit, such as the consumer selecting a button, checking a box, selecting a link that says “commit” or some other similar message.

The consumer may then be asked to decide, at step 108, whether the commitment is irrevocable. If the offer is for a group purchase of a single item, such as a condo rental, each member of the group may be asked to communicate the intent for an irrevocable commitment to a payment or service provider, such as PayPal, Inc. of San Jose, Calif. This can be done in any number of ways. For example, a member may log into the user's account with the payment provider, where a group purchase can be seen and an appropriate option selected by the user to convey the commitment. In another example, a member may send an email or text request to the payment provider with details of a commitment, such as the amount to be committed, the reason (e.g., the item being purchased by the group), other members of the group, the seller/merchant information, etc.

If the group offer is for the individual purchases of group members of the offered item(s), the consumer may select a button or link on a seller site, which communicates information to the payment provider. Other means may also be suitable, such as a phone call, email, etc.

The consumer may be informed that by conveying the intent to commit irrevocably to the group offer, the consumer is basically committing non-refundable funds to the group offer if the group offer is met by the group. In other words, the consumer cannot later decide to not be part of the group purchase and get the funds refunded. However, if the group offer cannot be completed, e.g., when an insufficient number of purchases have committed, the consumer's funds may be returned.

If the consumer conveys a request for an irrevocable commitment to the group offer, the payment provider may process the request at step 110. Note that the consumer may need to log in or otherwise be authenticated by the payment provider before processing.

Processing may include determining whether a valid user account exists, accessing the account, determining any restrictions or limitations on the account, such as maximum payment amount, maximum transactions, etc., location associated with the account, location of the request, and amount of the request.

The processing results in a determination, at step 112, whether the request can be approved. If not approved, the consumer may be asked to reenter information, provide a different funding source, or to further authenticate. If the request still cannot be approved, the consumer and/or other members of the group may be notified that the consumer was not preauthorized or committed to the group offer.

However, if approved, funds are committed to the group purchase at step 114. The funds may be held by the payment provider, such that the funds are treated as used, but the consumer is not yet obligated to pay or to withdraw the amount from a funding source to fund the payment provider account. Another way to commit the funds is to move them to a holding account, where other group members may also have their funds held. In yet another example, the funds may be transferred to the seller or merchant, but held until the group purchase can be made.

The funds may be held or committed until a determination can be made whether the group offer can be met, at step 116. One reason the group offer cannot be met is that the offer expired or was withdrawn before the conditions of the offer have been met. Conditions may include a certain number of committed consumers, a certain dollar amount for a group offer, etc. If one or more of the conditions are not met, the funds held or committed are released back to the consumer at step 118. Depending on how the funds were committed, the release back may be done in different ways, such as returning the funds back to the consumer's account from a merchant account or holding account, crediting the amount back to the consumer account, etc. The consumer and/or the merchant may be notified accordingly, such as through text or voice via a mobile device, PC, phone or other device.

However, if the group offer is satisfied, the payment provider may process the payment at step 120. Processing may include actually debiting funds from the consumer account or a holding account and crediting an account of the merchant or seller or informing the merchant that held funds in a merchant account can now be used. The merchant and/or consumer may also be notified that payment has been made, so that the merchant can release or deliver the purchased item(s) to the consumer and others in the group.

Note that one or more steps described herein may be omitted, combined, or performed in a different sequence as desired.

As such, consumers interested in and committed to a group purchase can be ensured that once others in the group commit, those commitments can be relied upon, even if one or more members of the group change their minds. This prevents a group offer from not being fulfilled when group members commit. For example, using the condo rental example, if ten members of a group are needed to participate in the condo rental and all ten members commit to the condo rental, if one or more members decide later that they do not want to be a part of the group, the remaining members may not be able to secure the condo or a replacement condo in time, resulting in a lost opportunity for the group. However, with the process described above, all members of the group can be sure that the condo rental is locked in, regardless of whether one or more members later change their mind.

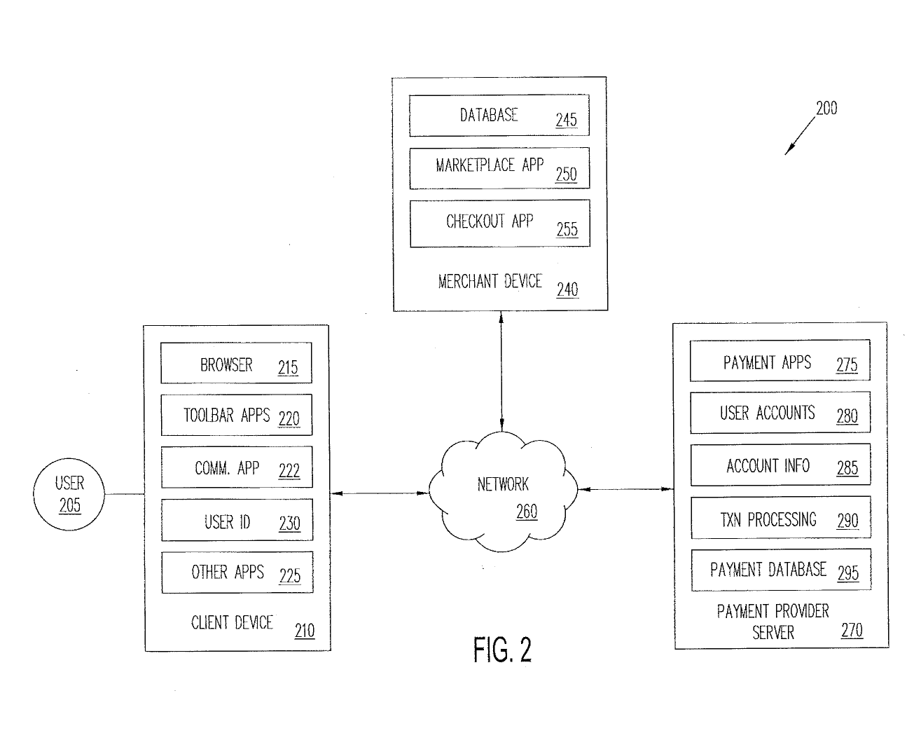

FIG. 2 is a block diagram of a networked system 200 configured to handle a financial transaction between a payment recipient (e.g., merchant) and a payment sender (e.g., user or consumer), such as described above, in accordance with an embodiment of the invention.

System 200 includes a user device 210, a merchant server 240, and a payment provider server 270 in communication over a network 260. Payment provider server 270 may be maintained by a payment provider, such as PayPal, Inc. of San Jose, Calif. A user 205, such as the sender or consumer, utilizes user device 210 to perform a payment transaction with merchant server 240 using payment provider server 270 or to convey a desire to make a payment to the payment provider so that the payment provider may commit the user to a group offer as described herein.

User device 210, merchant server 240, and payment provider server 270 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 200, and/or accessible over network 260.

Network 260 may be implemented as a single network or a combination of multiple networks. For example, in various embodiments, network 260 may include the Internet or one or more intranets, landline networks, wireless networks, and/or other appropriate types of networks.

User device 210 may be implemented using any appropriate hardware and software configured for wired and/or wireless communication over network 260. For example, in one embodiment, the user device may be implemented as a personal computer (PC), a smart phone, personal digital assistant (PDA), laptop computer, and/or other types of computing devices capable of transmitting and/or receiving data, such as an iPad™ from Apple™

User device 210 may include one or more browser applications 215 which may be used, for example, to provide a convenient interface to permit user 205 to browse information available over network 260. For example, in one embodiment, browser application 215 may be implemented as a web browser configured to view information available over the Internet. User device 210 may also include one or more toolbar applications 220 which may be used, for example, to provide client-side processing for performing desired tasks in response to operations selected by user 205. In one embodiment, toolbar application 220 may display a user interface in connection with browser application 215 as further described herein.

User device 210 may further include other applications 225 as may be desired in particular embodiments to provide desired features to user device 210. For example, other applications 225 may include security applications for implementing client-side security features, programmatic client applications for interfacing with appropriate application programming interfaces (APIs) over network 260, or other types of applications.

Applications 225 may also include email, texting, voice and IM applications that allow user 205 to send and receive emails, calls, and texts through network 260, as well as applications that enable the user to communicate, place orders, make payments, make payment requests, and make payment commitments through the payment provider as discussed above. User device 210 includes one or more user identifiers 230 which may be implemented, for example, as operating system registry entries, cookies associated with browser application 215, identifiers associated with hardware of user device 210, or other appropriate identifiers, such as used for payment/user/device authentication. In one embodiment, user identifier 230 may be used by a payment service provider to associate user 205 with a particular account maintained by the payment provider as further described herein. A communications application 222, with associated interfaces, enables user device 310 to communicate within system 200.

Merchant server 240 may be maintained, for example, by a merchant or seller offering various products and/or services in exchange for payment to be received over network 260. Generally, merchant server 240 may be maintained by anyone or any entity that receives money, which includes charities and service providers as well as retailers and restaurants. Merchant server 240 includes a database 245 identifying available products and/or services (e.g., collectively referred to as items) which may be made available for viewing and purchase by user 205, including receipts associated with identifiers, such as barcodes. Accordingly, merchant server 240 also includes a marketplace application 250 which may be configured to serve information over network 260 to browser 215 of user device 210. In one embodiment, user 205 may interact with marketplace application 250 through browser applications over network 260 in order to view various products, food items, or services identified in database 245.

Merchant server 240 also includes a checkout application 255 which may be configured to facilitate the purchase by user 205 of goods or services identified by marketplace application 250. Checkout application 255 may be configured to accept payment information from or on behalf of user 205 through payment service provider server 270 over network 260. For example, checkout application 255 may receive and process a payment confirmation or pre-authorization from payment service provider server 270, as well as transmit transaction information to the payment provider and receive information from the payment provider (e.g., a preauthorization or commitment). Checkout application 255 may also be configured to accept one or more different funding sources for payment, as well as create an invoice or receipt of the transaction.

Payment provider server 270 may be maintained, for example, by an online payment service provider which may provide payment between user 205 and the operator of merchant server 240. In this regard, payment provider server 270 includes one or more payment applications 275 which may be configured to interact with user device 210 and/or merchant server 240 over network 260 to facilitate the purchase of goods or services by user 205 of first user device 210 as part of a group offer or purchase as discussed above.

Payment provider server 270 also maintains a plurality of user accounts 280, each of which may include account information 285 associated with individual users. For example, account information 285 may include private financial information of users of devices such as account numbers, passwords, device identifiers, user names, phone numbers, credit card information, bank information, or other financial information which may be used to facilitate online transactions by user 205. Advantageously, payment application 275 may be configured to interact with merchant server 240 on behalf of user 205 during a transaction with checkout application 255 to track and manage commitments made by users and which funding sources are used.

A transaction processing application 290, which may be part of payment application 275 or separate, may be configured to receive information from a user device and/or merchant server 240 for processing and storage in a payment database 295. Transaction processing application 290 may include one or more applications to process information from user 205 for processing an order and payment at a merchant POS as described herein. As such, transaction processing application 290 may store details of a payment commitment associated with a group order. Payment application 275 may be further configured to determine the existence of and to manage accounts for user 205, as well as create new accounts if necessary.

Payment database 295 may store transaction details from completed transactions, including pre-authorization details and/or details of the transaction. Such information may also be stored in a third party database accessible by the payment provider and/or the merchant.

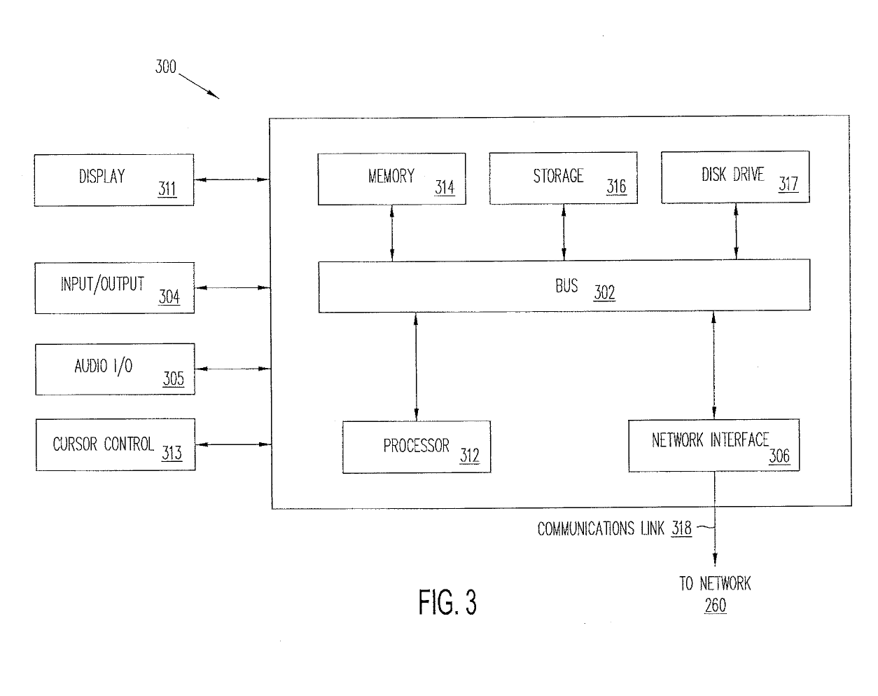

FIG. 3 is a block diagram of a computer system 300 suitable for implementing one or more embodiments of the present disclosure. In various implementations, the user device may comprise a personal computing device (e.g., a personal computer, laptop, smart phone, PDA, Bluetooth device, key FOB, badge, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 300 in a manner as follows.

Computer system 300 includes a bus 302 or other communication mechanism for communicating information data, signals, and information between various components of computer system 300. Components include an input/output (I/O) component 304 that processes a user action, such as selecting keys from a keypad/keyboard, selecting one or more buttons or links, etc., and sends a corresponding signal to bus 302. I/O component 304 may also include an output component, such as a display 311 and a cursor control 313 (such as a keyboard, keypad, mouse, etc.). An optional audio input/output component 305 may also be included to allow a user to use voice for inputting information by converting audio signals. Audio I/O component 305 may allow the user to hear audio. A transceiver or network interface 306 transmits and receives signals between computer system 300 and other devices, such as another user device, a merchant server, or a payment provider server via network 360. In one embodiment, the transmission is wireless, although other transmission mediums and methods may also be suitable. A processor 312, which can be a micro-controller, digital signal processor (DSP), or other processing component, processes these various signals, such as for display on computer system 300 or transmission to other devices via a communication link 318. Processor 312 may also control transmission of information, such as cookies or IP addresses, to other devices.

Components of computer system 300 also include a system memory component 314 (e.g., RAM), a static storage component 316 (e.g., ROM), and/or a disk drive 317. Computer system 300 performs specific operations by processor 312 and other components by executing one or more sequences of instructions contained in system memory component 314. Logic may be encoded in a computer readable medium, which may refer to any medium that participates in providing instructions to processor 312 for execution. Such a medium may take many forms, including but not limited to, non-volatile media, volatile media, and transmission media. In various implementations, non-volatile media includes optical or magnetic disks, volatile media includes dynamic memory, such as system memory component 314, and transmission media includes coaxial cables, copper wire, and fiber optics, including wires that comprise bus 302. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 300. In various other embodiments of the present disclosure, a plurality of computer systems 300 coupled by communication link 318 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a memory storing information about user accounts, where the information comprises user commitments to group purchases; and
one or more hardware processors in communication with the memory, wherein the processor(s) performs:
receiving, from a user device of a user via an electronic communication network, a request to commit to a group purchase offered by a seller;
communicating, via the electronic communication network to the user device, a notification indicating to the user that a payment from the user is to be committed to the group purchase and that the payment is irrevocable by the user unless the group purchase cannot be completed by the seller;
receiving, from the user device, an irrevocable payment request for the group purchase;
processing the irrevocable payment request;
committing an irrevocable payment from a user account of the user to the group purchase, wherein the irrevocable payment is irrevocable by the user; and
releasing the irrevocable payment to the seller when group purchase conditions are satisfied.

2. The system of claim 1, wherein the group purchase is for a single item shared by members of a group.

3. The system of claim 1, wherein the group purchase is for a single item for each member of a group.

4. The system of claim 1, wherein the processor(s) further performs receiving an initial intent by the user to participate in the group purchase.

5. The system of claim 1, wherein the processor(s) further performs releasing the irrevocable payment back to the user if the group purchase cannot be completed.

6. The system of claim 5, wherein the group purchase cannot be completed when a number of members committed in the group purchase does not reach a predetermined number to obtain a discount for the group purchase.

7. The system of claim 1, wherein the committed irrevocable payment is held in a seller account.

8. The system of claim 1, wherein the committed irrevocable payment is held in a holding account of a payment provider.

9. A non-transitory machine-readable medium comprising a plurality of machine-readable instructions which when executed by one or more processors of a server are adapted to cause the server to perform a method comprising:
receiving, from a user device of a user via an electronic communication network, a request to commit to a group purchase offered by a seller;
communicating, via the electronic communication network to the user device of the user, a notification indicating to the user that a payment from the user is to be committed to the group purchase and that the payment is irrevocable by the user unless the group purchase cannot be completed by the seller;
receiving, from the user device of the user, an irrevocable payment request for the group purchase;
processing the irrevocable payment request;
committing an irrevocable payment from a user account of the user to the group purchase, wherein the irrevocable payment is irrevocable by the user; and
releasing the irrevocable payment to the seller when group purchase conditions are satisfied.

10. The non-transitory machine-readable medium of claim 9, wherein the group purchase is for a single item shared by members of a group.

11. The non-transitory machine-readable medium of claim 9, wherein the group purchase is for a single item for each member of a group.

12. The non-transitory machine-readable medium of claim 9, wherein the method further comprises receiving an initial intent by the user to participate in the group purchase.

13. The non-transitory machine-readable medium of claim 9, wherein the method further comprises releasing the irrevocable payment back to the user if the group purchase cannot be completed.

14. The non-transitory machine-readable medium of claim 13, wherein the group purchase cannot be completed due to expiration of a group offer.

15. A method of processing a financial transaction, comprising:
receiving, by a hardware processor of a payment provider from a user device of a user via an electronic communication network, a request to commit to a group purchase offered by a seller;
communicating, via the electronic communication network to the user device of the user, a notification indicating to the user that a payment from the user is to be committed to the group purchase and that the payment is irrevocable by the user unless the group purchase cannot be completed by the seller;
receiving, from the user device of the user, an irrevocable payment request for the group purchase;
processing, by the hardware processor of the payment provider, the irrevocable payment request;
committing, electronically by the processor, an irrevocable payment from a user account of the user to the group purchase, wherein the irrevocable payment is irrevocable by the user; and
releasing the irrevocable payment to the seller when group purchase conditions are satisfied.

16. The method of claim 15, wherein the group purchase is for a single item shared by members of a group.

17. The method of claim 15, wherein the group purchase is for a single item for each member of a group.

18. The method of claim 15, further comprising receiving, by the processor, an initial intent by the user to participate in the group purchase.

19. The method of claim 15, further comprising releasing the irrevocable payment back to the user if the group purchase cannot be completed.

20. The method of claim 19, wherein the group purchase cannot be completed because a group offer is withdrawn by the seller.
